(19) United States
(12) Patent Application Publication
(10) Pub. No.: US 2008/0298647 A1
(43) Pub. Date: Dec. 4, 2008

(54) System and Method for Identifying an Enrolled User Utilizing a Biometric Identifier

(75) Inventors: Fraser Orr, Naperville, IL (US); David Delgrosso, Naperville, IL (US); Anthony Franciskovich, Lockport, IL (US); Jason Shaver, Bolingbrook, IL (US)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(73) Assignee: US BIOMETRICS CORPORATION, Naperville, IL (US)

(21) Appl. No.: 12/108,849

(22) Filed: Apr. 24, 2008

Related U.S. Application Data
(63) Continuation-in-part of application No. 11/400,037, filed on Apr. 7, 2006.
(60) Provisional application No. 60/669,535, filed on Apr. 8, 2005.

(51) Int. Cl. G06K 9/62

(52) U.S. Cl. 382/124

(57) ABSTRACT

A system and method for obtaining a first alphanumeric identifier from a user, obtaining a first fingerprint scan image of a first finger from the user, comparing the first fingerprint scan image to a first image associated with the first alphanumeric identifier stored in a database at a first threshold level and, comparing the first fingerprint scan image to the first image stored in the database associated with the first alphanumeric identifier at a second threshold level lower than the first threshold level if a match is not made at the first threshold level. The system can include a computer or other similar terminal or device and a fingerprint scanner connected to the computer.

### CROSS-REFERENCE TO RELATED APPLICATIONS

This application is a continuation-in-part application of U.S. patent application Ser. No. 11/400,037, filed Apr. 7, 2006, which, in turn, claims the benefit of U.S. Provisional Patent Application No. 60/669,535, filed Apr. 8, 2005. The contents of both Applications are herein incorporated by reference.

### FEDERALLY SPONSORED RESEARCH OR DEVELOPMENT

Not Applicable.

### TECHNICAL FIELD

The invention generally relates to an improved system and method for identifying a user of a device or software application via a biometric identifier; and more particularly, to a system and method for identifying a user of a device or software application via a biometric identifier after an initial attempt fails.

### BACKGROUND OF THE INVENTION

A biometric identifier, such as a fingerprint or iris scan, can be utilized in a variety of devices and/or software applications as a security measure to allow only authorized users access to the device or application. In many cases, the device or application will first request a user to enter some identifying information, such as a name, social security number or phone number. The device or application then obtains a biometric identifier from a scanner connected to the device or computer terminal running the application and compares the scanned identifier with one contained in a database of enrolled users.

In some instances a match is not found even though a user is legitimately enrolled as an authorized user of the device or application. This occurs (in a fingerprint example) because no two fingerprint scans are ever exactly alike. That is, factors such as twisting or distortion of the skin on the finger, level of pressure, change in moisture content, etc., cause a slightly different image being captured for each scan. Most fingerprint scanners determine a measure of similarity between the subsequently scanned fingerprint and the fingerprint stored in the database. If the scanned fingerprint does not meet a set threshold of similarity, the system won't consider it a match and refused access. The user would then get a prompt to “Please Try Again” and the whole procedure would repeat.

The present invention is provided to solve the problems discussed and to provide advantages and aspects not provided by prior systems or methods. A full discussion of the features and advantages of the present invention is deferred to the following detailed description, which proceeds with reference to the accompanying drawings.

### SUMMARY OF INVENTION

The present invention provides a system and method that facilitates identification of an enrolled or authorized user of a system or application. In particular, the invention assists in identifying a user after an initial attempt (or attempts) fails. The system is used in instances requiring biometric identification.

In accordance with one aspect of the invention, a method for successfully identifying an enrolled or otherwise authorized user of an application is provided. The application can run on a personal computer or other terminal or similar device, or be available over the Internet. The method includes obtaining a first alphanumeric identifier from a user, such as the user's phone number. The alphanumeric identifier can be inputted by any number of known means, such as a keyboard or touch screen, associated with a device or computer terminal.

The method further includes obtaining a first fingerprint scan image of a first finger from the user. This can be accomplished via a fingerprint scanner coupled to the computer or terminal. This is followed by making a first attempt at comparing the first fingerprint scan image to a first image associated with the first alphanumeric identifier stored in a database (if more than one person is associated with the phone number, the method can include first selecting the name of the user). The comparison is performed at a first threshold level. If there is a match, the user is granted access to the application.

If a match cannot be made, the method includes making a second attempt at comparing the first fingerprint scan image to the first image stored in the database associated with the first alphanumeric identifier. However, the second attempt is performed at a second threshold level lower than the first threshold level.

Additionally, the method can include additional security features if a match is made at the second threshold level. In particular, the method can further include obtaining from the user a second alphanumeric identifier upon matching the first fingerprint scan image to the first image stored in the database associated with the first alphanumeric identifier at the second threshold level. The second alphanumeric identifier can be a social security number or other user specific credentials stored in the database that is associated with the first image. Upon successfully verifying the second alphanumeric identifier, the method includes granting the user access to the application as an identified authorized enrolled user.

The method can also include displaying tips for scanning a fingerprint upon failure to match the first fingerprint scan image with the first image stored in the database at the second threshold level. These can include tips on positioning of the finger, amount of pressure to apply, use of a moisturizer, etc. After the tips are displayed, the method includes obtaining a second fingerprint scan image of the first finger from the user and, comparing the second fingerprint scan image to the first image stored in a database associated with the first alphanumeric identifier at the first threshold level. Again, if a match is not made at the first level, the method includes comparing the second fingerprint scan image to the first image stored in the database associated with the first alphanumeric identifier at the second threshold level. The additional security measure discussed above can also be implemented at this point.

The method can also include obtaining a first fingerprint scan image of a second finger from the user upon failure to match the first fingerprint scan image of the first finger with the first image stored in the database and, comparing the first fingerprint scan image of the second finger to a second image stored in a database associated with the first alphanumeric identifier at a first threshold level.

If a match is not made at the first threshold level with the second finger, the method includes comparing the first fingerprint scan image of the second finger to the second image stored in the database associated with the first alphanumeric identifier at the second threshold. Again, the additional security measure can be implemented.

In accordance with another aspect of the invention, a system for identifying an enrolled user of an application is provided. The system includes a fingerprint scanning device and, a terminal (e.g., a computer/server, or a device such as an ATM, etc.) coupled to the fingerprint scanning device. The terminal also includes a display and an alphanumeric input. The terminal is coupled to a database of enrolled users. The database includes information of each enrolled user and one or more stored fingerprint images (of one or more of the user's fingers). The database can be local or accessible over a network connection.

The terminal is configured to receive a first alphanumeric identifier inputted by a user and a first fingerprint scan image of a first finger from the user via the fingerprint scanning device, and compare the first fingerprint scan image with a first image associated with the alphanumeric identifier stored in a database. Again, if more than one user is associated with the phone number, then the terminal is configured to display a list of users and request selection of the user. The first comparison is performed at a first threshold level. The terminal is further configured to compare the first fingerprint scan image with the first image stored in the database at a second threshold level lower than the first threshold level if a match is not made with the comparison at the first threshold level.

The terminal can also be configured to obtain an inputted second alphanumeric identifier from the user associated with the first image stored in the database upon matching the first fingerprint scan image to the first image stored in the database at the second threshold level. After receipt of this additional security the measure, the terminal grants access to the application upon matching the inputted second alphanumeric identifier to data associated with the first image stored in the database.

The terminal is configured to display tips for scanning a fingerprint upon failure to match the first fingerprint scan image with the first image stored in the database at the second threshold level. It then obtains a second fingerprint scan image of the first finger from the user, and compares the second fingerprint scan image to the first image stored in the database at the first threshold level.

If the second scan of the first finger fails, the terminal is configured to obtain a first fingerprint scan image of a second finger of the user, and compare the first finger print image of the second finger with the first image stored in the database at a first threshold level. The terminal is configured to compare the first fingerprint scan image of the second finger with the first image stored in the database at the second threshold level if a match is not made at the first threshold level.

According to yet a further aspect of the invention, a method for facilitating use of a biometric scanner for granting a current user access to a software application is provided. The method includes providing a biometric scanner coupled to a computer terminal (such as a fingerprint scanner or an iris scanner, for example), and providing a database of a plurality of enrolled users, the database containing enrolled user information including the first alphanumeric identifier and at least one biometric identifier associated with each enrolled user. The method also includes obtaining a first alphanumeric identifier of a current user and locating the first alphanumeric identifier in the database. Additionally, the method includes obtaining a first biometric identifier from the current user and comparing the first biometric identifier from the current user with the at least one biometric identifier associated with the enrolled user of the located first alphanumeric identifier at a first threshold level. If a match is not made, the method includes comparing the first biometric identifier from the current user with the at least one biometric identifier associated with the enrolled user of the located first alphanumeric identifier at a second threshold level.

The method also includes obtaining a second alphanumeric identifier of the user upon finding a match of the first biometric identifier from the current user with the at least one biometric identifier associated with the enrolled user of the located first alphanumeric identifier at the second threshold level and comparing the second alphanumeric identifier with the user information contained in the database for the enrolled user. Further the method can include granting access to the application upon a match of the second alphanumeric identifier with the user information of the enrolled user of the located first alphanumeric identifier.

Other features and advantages of the invention will be apparent from the following specification taken in conjunction with the following drawings.

### BRIEF DESCRIPTION OF THE DRAWINGS AND ATTACHMENTS

To understand the present invention, it will now be described by way of example, with reference to the accompanying drawings in which:

FIGS. 1A and 1B are flow charts illustrating the steps and decisions executed by the system and method of the present invention;

FIG. 2 is a screenshot of a dialog box displaying tips for scanning a fingerprint in accordance with an aspect of the present invention;

FIG. 3 is a screenshot of a dialog box displaying a request for due diligence in accordance with an aspect of the present invention;

FIG. 4 is a perspective of a computer coupled to a fingerprint scanner in accordance with the present invention;

FIG. 5 is a perspective view of a terminal implementing the present system and method that can be utilized in a drive-up lane of a financial institution or other facility; and,

FIG. 6 is a remote teller terminal implementing the present system and method that can be utilized inside a financial institution or other facility.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present system and method are utilized for identifying an authorized or previously enrolled user of a device, terminal or computer system, and/or software application, using a biometric identifier, such as a fingerprint scan image. In particular, the system and method are designed to facilitate identification of the user in the event an initial attempt (or attempts) does not result in a positive match between the biometric identifier (e.g., fingerprint scan image) taken at a the time the user is trying to use the system, and a biometric identifier of the user stored in a database accessible by the system (e.g., stored fingerprint image). The system and method can be used to grant a user access to a variety of devices, systems and/or applications (e.g., software or websites) in a variety of fields. The present system and method improve the chance of successfully identifying the enrolled user (e.g., a banking customer or teller) and can be incorporated in the device, terminal or personal computer, or a server networked with a one or more devices, terminals, and/or computers.

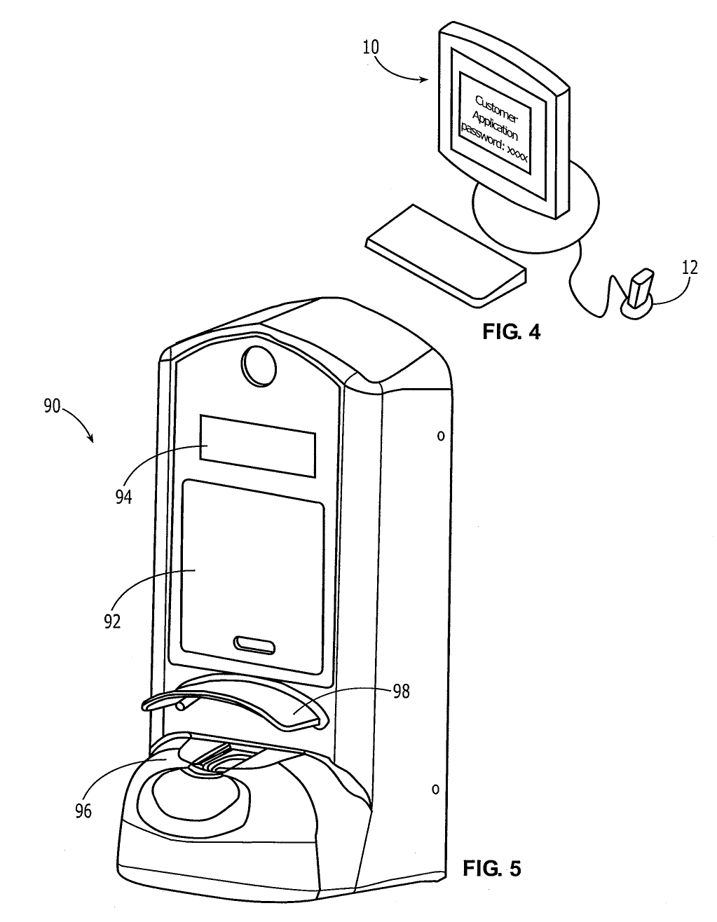

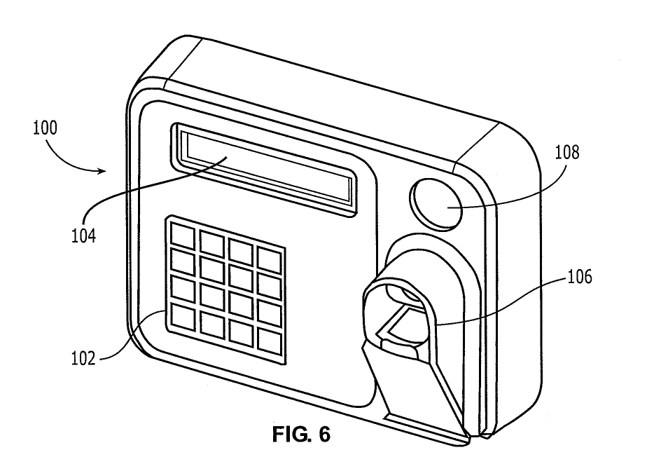

In one preferred form of the invention, the system and method are incorporated in remote drive-up lane terminals (see FIG. 5) and/or teller stations (see FIG. 6) of a financial institution or other facility requiring biometric identification, and can be used to identify both customers of the financial institution as well as tellers and other authorized financial institution or facility personal. The functionality of the system allows for providing a queue of customer using a plurality of remote terminals (i.e., either teller stations or drive-up lanes). Tellers can then assist customers one at a time, based on first come/first served format.

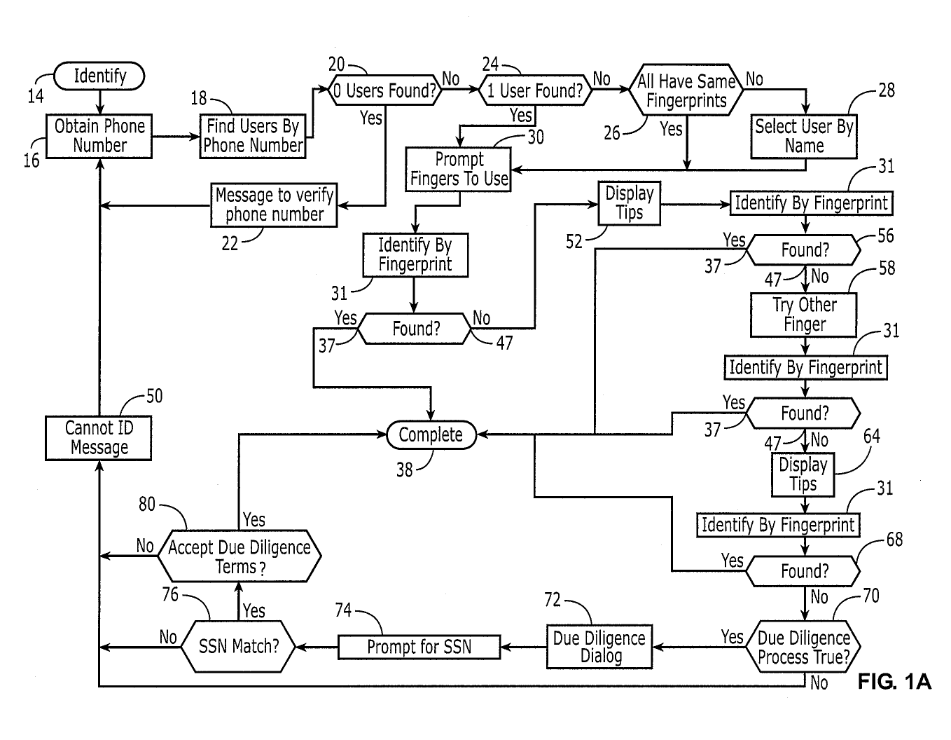

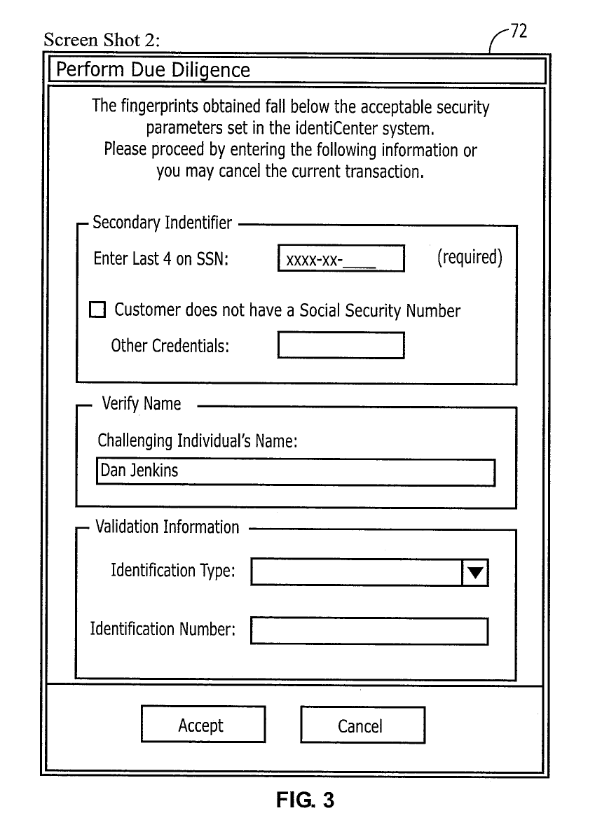

FIGS. 1A and 1B illustrate the steps/decisions taken by the present system to identify an enrolled user of a system or application. By way of example, the process is discussed in connection with a user interacting with a terminal or computer 10 coupled to a fingerprint scanner 12 as shown in FIG. 4. The computer 10 includes a display and a keyboard (however, other input means, such as a touch screen can be used). The terminal or computer can be incorporated into a kiosk or teller station inside a financial institution (e.g., a bank), or included in drive-up lanes.

The user's interaction with the computer 10 can include more than one operation. In this regard, the user may simply use the computer for obtaining general information. For example, the user can navigate to a bank's website for information regarding services, location, hours, etc.

However, in some instances the user may use the computer to access applications that require the user to be authorized. Referring to the banking example, only authorized users are allowed to access account information. The present system is involved when the user seeks access to such an application.

Referring to FIGS. 1A and 1B, the “Identify” process 14 begins with a request for a first alphanumeric identifier 16 from the user. In this case, the system obtains the user's phone number as the first alphanumeric identifier, however other identifiers can be used. The first alphanumeric identifier can be entered via the keyboard or a number pad associated with the computer. The computer 10 then attempts to locate all enrolled users associated with the inputted phone number 18 in a database associated with the system.

This subset of enrolled users should be rather small (e.g., several members of a family). If no users are found 20, a message is displayed on the computer display requesting the user to verify or reenter the phone number 22. If one or more users are found, the system determines if only one user is associated with the phone number 24.

If more than one user is associated with the phone number, the system determines if all of the users have the same fingerprints registered 26 (i.e., all of the users have the same fingers scanned and stored in the database, such as the right and left index fingers). If not, the enrolled user names associated with the phone number are displayed and the present user can select the appropriate name 28. Alternatively, the system can simply go directly to displaying the user names for selection.

If one user is found, or all of the enrolled users associated with the phone number have the same fingerprints registered, or a name was selected by the user, the system prompts the present user to scan a particular finger (e.g., right index) 30 with the fingerprint scanner 12. The system then proceeds to attempt to identify the user by the user's fingerprint 31.

As illustrated in FIG. 1B, the system obtains the scanned fingerprint image 32. It then makes a first attempt to match the scanned fingerprint image with an image of the fingerprint stored in the database that is associated with the user (or with one of the plurality of users associated with the phone number) at a first—high—threshold level 34. The fingerprints images and other data associated with the enrolled users can be obtained when the user initially enrolls with the system.

The threshold level is a test of similarity between the scanned image and the stored image. For example, when a fingerprint scanner captures a fingerprint, called a “test” fingerprint, it compares it to a database of, so called, “sample” prints for matching. However, no two fingerprints are ever captured exactly alike. Due to twisting and distortion of the skin, different levels of pressure, and changes in moisture, the image captured is slightly different than the stored image, even though the fingerprint on the skin has not changed.

Consequently, when comparing fingerprints a system will never find an exact match. What you have to do is find a measure of similarity, so that you can say that A is similar to B, and give some numeric measure of similarity.

With this in mind, when we are searching for who a test fingerprint belongs to in a database of sample fingerprints, we scan through the database, and calculate the similarity score. If the score is greater than a certain number, called the threshold, then the test and sample are considered a match, if below, it is considered not a match. This discussion assumes that the measure of similarity increases with increasing similarity. Some schemes do use the reverse, and in such cases the discussion should be altered in the obvious manner.

With this scheme there are two modes of error. Given two fingerprints, the test print T, and the sample print S: if T and S have a similarity score above the threshold, but are in fact from different fingers, this is called a false match, or more commonly a false accept; if T and S have a similarity score below the threshold, but are in fact from the same fingerprint, this is called a false non match, or more commonly a false reject.

In practical applications these sorts of errors do occur (technically this is because the intra-class variability of a set of images from the same fingerprint, is larger than the inter-class variability between some fingerprints, which are from different fingers). The rate at which they occur, at a given threshold are called the false accept rate (FAR) and the false reject rate (FRR.) Note that these rates can only be measured for any particular threshold.

By increasing the threshold, the decrease the number of matches, which means you increase the FRR, but decrease the FAR. By decreasing the threshold, the increase the FAR, but decrease the FRR.

So lowering the threshold allows for more liberal matching, which, in this particular case is tuned to decrease the FRR, (though increasing the FAR), since we handle the false accept case using other criteria.

Referring back to FIG. 1B, if the user's fingerprint scan image matches the image stored in the database 36, the system determines that the user has been found 37 and completes identification 38. The user is then granted access to the desired application.

However, if a match is not made, the system attempts to match the user's fingerprint scan image with the image stored in the database 36 at a second threshold level lower than the first threshold level 40. The system then determines if there is a match at the lower level 42. If so, the system prompts the user to input an additional alphanumeric identifier, such as a social security number (or a portion thereof, such as the last four digits) 44. The system then determines whether the inputted social security number matches the number in the database associated with the stored fingerprint image 46. If it matches the identification is completed 38 and the system grants the user access to the desired application.

If the social security number does not match 48, the system displays a message that it cannot identify the user as an enrolled user 50. The system can then, in effect, start over with a prompt for the user's phone number 16. If the system cannot match the fingerprint at the lower level it determines the user is not found in the system 47.

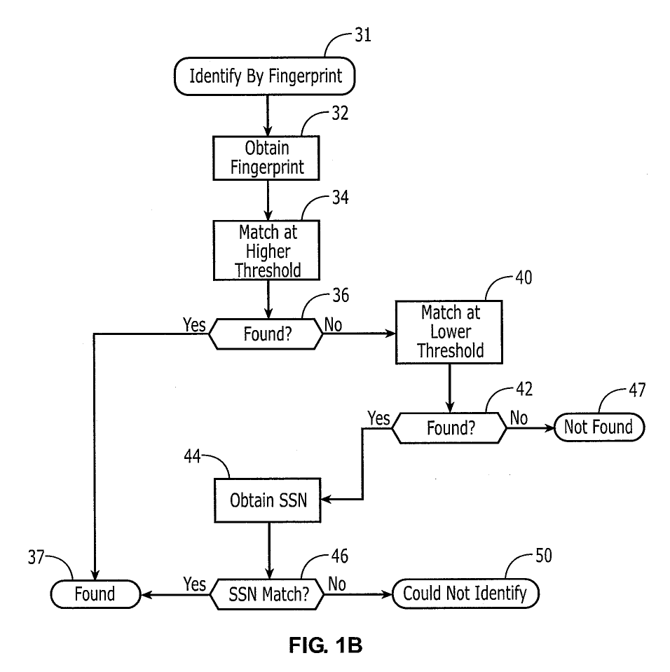

In the event the system cannot make a match at the lower threshold level, it displays tips to the user (as illustrated in FIG. 2) for scanning a fingerprint 52 and requests the user to scan the same finger again 54. The system then attempts to identify the second scan image of the fingerprint at the first higher threshold level in the same manner as it initially tried to find a match 31 (as illustrated in FIG. 1B).

If the system cannot make a match, the user is prompted to use a second finger 58. This assumes that at least two fingers were scanned during enrollment of the user. The second finger is scanned and the scanned image is compared to a stored image of the second finger in the same manner as described above 31.

If the system cannot match the second finger scanned image, it will again display the tips 52 (at block 64) shown in FIG. 2. The system will request the user to scan the second finger again and attempt to find a match as described 31.

At this point, if a customer can not be identified with either enrolled finger at a standard threshold or the lower threshold the system determines if it should proceed to a due diligence option 70 which involves, in part, clearance from a service representative.

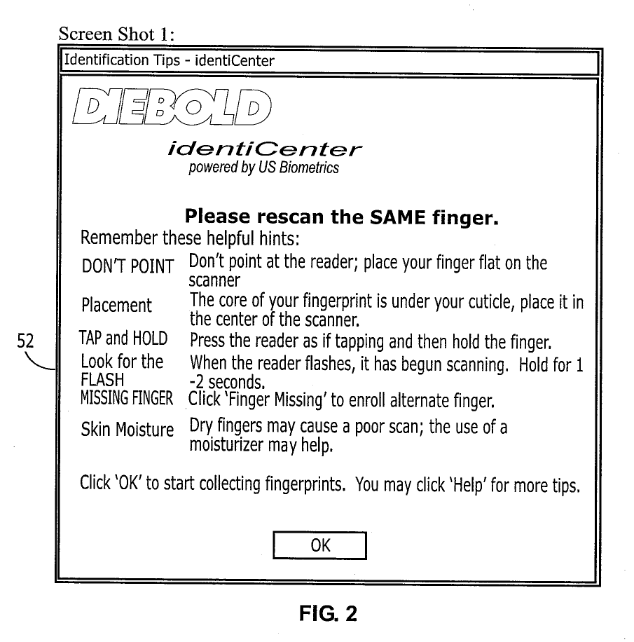

If due diligence is an option, the system displays a due diligence dialog 72 as illustrated in FIG. 3. The dialog requests input of a social security number (or the last four digits) or other form of credentials 74. If this data matches the stored enrolled data 76, the clerk or customer service representative must follow their normal procedures to identify a customer. This can include use of the customer's driver's license, state ID, military ID, etc . . . . The clerk must then submit the identification type and number to the system and choose to accept the Due Diligence processing 80. At this point the system records the due diligence processing for the customer and normal processing continues (i.e., identification is complete 32)

FIG. 5 shows a terminal 90 that can be utilized in a drive-up lane of a facility, such as a financial institution. The terminal 90 includes an alphanumeric keypad (or, in some cases, simply a number keypad) 92 and a display 94, such as a lcd display. The terminal 90 also includes a fingerprint scanner 96 with a cover 98 to shield the scanner from the environment.

The terminal 90 is environmental and security safe. The outdoor terminal 90 can be exposed to excessive heat, cold, rain and other elements. If the terminal is opened, cracked or removed from its pedestal the institutions computer network is secured by a series of tamper sensors and light emitting sensors which when triggered send a message to the enterprise server to disable the terminal's line to the network.

FIG. 6 shows a terminal 100 that can be utilized as or with a teller station inside the facility (e.g., the terminal can control access—by unlocking a door—to the teller station). The terminal 100 includes an alphanumeric keypad 102 (again, a keypad having only numbers can be used), and a display 104. The terminal 100 also includes a fingerprint scanner 106. A light 108 is also provided to indicate when the door is unlocked.

The present identification system (and related method) can be incorporated in a larger, management system used by the financial institute (or other facility). The management system can include functionality for identifying and managing the tellers and other financial institute personnel, as well as identifying and servicing the institute's customers. The functionality of the management system is best described in terms of a number of typical or exemplary situations that can occur at the financial institution.

In accordance with one typical situation, a first teller at a main office having twelve drive-up customer lanes is assigned to cover lanes four through six. The teller logs onto the system (via a computer terminal, such as that shown in FIG. 4) and chooses the role or a remote teller from a menu of options. The teller then clicks on the remote devices menu item which is displayed on a portion of the screen. The teller can filter the lists of remote devices by the branch of the office the teller is at.

In one situation, the teller may be busy with a task when a first drive-up customer pulls up the drive-up terminal 90 in lane five. The first driver inputs their ten digit phone number into the device at 1:12 PM. Next a second drive-up customer in another car pulls up in drive-up lane four and enters their ten digit phone number at 1:14 PM. The teller finishes the task at hand and then clicks a GetNext button on the management systems tool bar. This establishes a service connection with the first drive-up customer.

In another situation, the first teller goes on break but leaves the “OPEN” light on lanes four through six. A second teller, working lanes one through three, notices a drive-up customer waiting in lane six. The second teller clicks on the remote devices menu item and notices the customer in lane six has been waiting for two minutes. The second teller can select lane six and click a Get Customer button to establish service with the customer in lane six.

Continuing with this situation, after the customer enters the phone number, the second teller can instruct the customer (via a microphone or a text message on the display) to place a particular finger on the fingerprint scanner. The second teller can then click a Check Fingerprint button—which initiates the identification process set forth above. This may include, if necessary, requesting the customer to enter a second alphanumeric identifier (such as a social security number) or rescan a finger after displaying tips, or requesting a scan of another finger. The system may display such requests automatically, or at prompting by the teller (via clicking appropriate buttons on the teller's terminal 90).

If successfully identified, normal servicing of the customer can occur. When the second teller completes the service, the teller can click the Clear Screen button which sends a message back to the remote terminal 90 saying “Thank You.” This lasts for about three seconds before the display goes back to a ready state (which displays the message “Please enter your phone number to begin.”).

If the customer cannot be identified by fingerprint scan, the Due Diligence processing would go into effect. A Due Diligence dialog box is displayed to the teller. The teller (over the microphone or via the display) requests a photo ID from the customer. The customer can then send the ID through a vacuum tube system to the teller. The teller can then copy or otherwise record the information from the ID and proceed with servicing the customer.

If two or more tellers are servicing the same drive-up lane, the first one to click the Get Next button will establish a connection to service the customer.

In another situation inside a financial institution, a customer can use a remote teller station. The remote teller station looks like a small open, office cubicle. The cubicle includes a phone, vacuum tube system, camera, financial institute forms, writing utensils and a remote teller station device 100. The display 104 of the device 100 initially indicates “Enter your phone number to begin” (this is also the initial display that can be used in the drive-up lanes). A teller clicking a Get Next button can then establish communication with the customer in the cubicle.

In addition to identifying an enrolled customer by fingerprint scan, the management system can be configured to also allow certain transactions via a card reader and a PIN number.

The management system or application includes a “My Role” tool bar button that allows financial institute personnel to select and/or change a role, such as a manager or teller. The “Get Next” button establishes communication between the management application and the terminal that is in a list of devices for the teller where the customer has been waiting the longest.

The management application allows the teller to request a fingerprint. This sends a message to the customer at the remote terminal (either the drive-up or inside remote teller) to use the fingerprint scanner, which identifies the customer as set forth above (upon which normal processing can occur) or provides a message to the teller that identification cannot be made. In the latter instance, the financial institute's due diligence identification can be employed.

While the specific embodiments have been illustrated and described, numerous modifications come to mind without significantly departing from the spirit of the invention, and the scope of protection is only limited by the scope of the accompanying Claims.

What is claimed is:

1. A method for successfully identifying an enrolled user of an application comprising the steps of:
obtaining a first alphanumeric identifier from a user;
obtaining a first fingerprint scan image of a first finger from the user;
comparing the first fingerprint scan image to a first image associated with the first alphanumeric identifier stored in a database at a first threshold level; and,
comparing the first fingerprint scan image to the first image stored in the database associated with the first alphanumeric identifier at a second threshold level lower than the first threshold level if a match is not made at the first threshold level.

2. The method of claim 1 further comprising the steps of:
obtaining from the user a second alphanumeric identifier upon matching the first fingerprint scan image to the first image stored in the database associated with the first alphanumeric identifier at the second threshold level, the second alphanumeric identifier associated with the first image stored in the database; and,
granting the user access to the application upon matching the second alphanumeric identifier with data associated with the first image stored in the database.

3. The method of claim 1 further comprising the steps of:
displaying tips for scanning a fingerprint upon failure to match the first fingerprint scan image with the first image stored in the database at the second threshold level;
obtaining a second fingerprint scan image of the first finger from the user; and,
comparing the second fingerprint scan image to the first image stored in a database associated with the first alphanumeric identifier at the first threshold level.

4. The method of claim 3 further comprising the step of:
comparing the second fingerprint scan image to the first image stored in the database associated with the first alphanumeric identifier at the second threshold level if a match is not made at the first threshold level.

5. The method of claim 4 further comprising the steps of:
obtaining from the user a second alphanumeric identifier upon matching the second fingerprint scan image to the image stored in the database associated with the first alphanumeric identifier at the second threshold level, the second alphanumeric identifier associated with the first image stored in the database; and,
granting the user access to the application upon matching the second alphanumeric identifier with data associated with the first image stored in the database.

6. The method of claim 1 further comprising the steps of:
obtaining a first fingerprint scan image of a second finger from the user upon failure to match the first fingerprint scan image of the first finger with the first image stored in the database; and,
comparing the first fingerprint scan image of the second finger to a second image stored in a database associated with the first alphanumeric identifier at the first threshold level.

7. The method of claim 6 further comprising the step of:
comparing the first fingerprint scan image of the second finger to the second image stored in the database associated with the first alphanumeric identifier at the second threshold if a match is not made at the first threshold level.

8. The method of claim 7 further comprising the steps of:
obtaining from the user a second alphanumeric identifier upon matching the first fingerprint scan image of the second finger to the second image stored in the database associated with the first alphanumeric identifier at the second threshold level, the second alphanumeric identifier associated with the second image stored in the database; and,
granting the user access to the application upon matching the second alphanumeric identifier with data associated with the second image stored in the database.

9. The method of claim 1 wherein the first alphanumeric identifier is a telephone number associated with the user.

10. The method of claim 9 further comprising the steps of:
identifying all enrolled users associated with the telephone number;
obtaining an identity of a select one of the enrolled users associated with the telephone number.

11. The method of claim 2 wherein the second alphanumeric identifier is a social security number.

12. A system for identifying an enrolled user of an application comprising:
a fingerprint scanning device; and,
a terminal coupled to the fingerprint scanning device, the terminal having a display and an alphanumeric input, the terminal configured to receive a first alphanumeric identifier inputted by a user and a first fingerprint scan image of a first finger from the user via the fingerprint scanning device, and compare the first fingerprint scan image with a first image associated with the alphanumeric identifier stored in a database at a first threshold level, the terminal further configured to compare the first fingerprint scan image with the first image stored in the database at a second threshold level lower than the first threshold level if a match is not made with the comparison at the first threshold level.

13. The system of claim 12 wherein the terminal is connected to a server coupled to the database via a network connection.

14. The system of claim 12 wherein the terminal is further configured to obtain an inputted second alphanumeric identifier from the user associated with the first image stored in the database upon matching the first fingerprint scan image to the first image stored in the database at the second threshold level, and grant access to the application upon matching the inputted second alphanumeric identifier to data associated with the first image stored in the database.

15. The system of claim 12 wherein the terminal is configured to display tips for scanning a fingerprint upon failure to match the first fingerprint scan image with the first image stored in the database at the second threshold level, obtain a second fingerprint scan image of the first finger from the user, and compare the second fingerprint scan image to the first image stored in the database at the first threshold level.

16. The system of claim 15 wherein the terminal is configured to obtain a first fingerprint scan image of a second finger of the user, and compare the first fingerprint image of the second finger with the first image stored in the database at a first threshold level.

17. The system of claim 16 wherein the terminal is configured to compare the first fingerprint scan image of the second finger with the first image stored in the database at the second threshold level if a match is not made at the first threshold level.

18. A method for facilitating use of a biometric scanner for granting a current user access to a software application comprising the steps of:
providing a biometric scanner coupled to a computer terminal;
obtaining a first alphanumeric identifier of a current user;
providing a database of a plurality of enrolled users, the database containing enrolled user information including the first alphanumeric identifier and at least one biometric identifier associated with each enrolled user;
locating the first alphanumeric identifier in the database;
obtaining a first biometric identifier from the current user;
comparing the first biometric identifier from the current user with the at least one biometric identifier associated with the enrolled user of the located first alphanumeric identifier at a first threshold level; and,
comparing the first biometric identifier from the current user with the at least one biometric identifier associated with the enrolled user of the located first alphanumeric identifier at a second threshold level if no match during comparison at the first threshold level.

19. The method of claim 18 further comprising the steps of:
obtaining a second alphanumeric identifier of the user upon finding a match of the first biometric identifier from the current user with the at least one biometric identifier associated with the enrolled user of the located first alphanumeric identifier at the second threshold level;
comparing the second alphanumeric identifier with the user information contained in the database for the enrolled user; and,
granting access to the application upon a match of the second alphanumeric identifier with the user information of the enrolled user of the located first alphanumeric identifier.

20. The method of claim 18 wherein the step of obtaining a first biometric identifier from the current user comprises obtaining a fingerprint scan image of a first finger of the current user.
